(19) United States
(12) Patent Application Publication
(10) Pub. No.: US 2022/0345858 A1
(43) Pub. Date: Oct. 27, 2022

(54) SYSTEMS AND METHODS FOR INTEGRATED APPLICATIONS OF HVAC SYSTEMS

(71) Applicant: Johnson Controls Tyco IP Holdings LLP, Milwaukee, WI (US)

(72) Inventors: Michael L. Sentz, York, PA (US); Troy E. Smith, Dallastown, PA (US); Kevin R. Stockton, York, PA (US); Aron M. Seiler, White Hall, MD (US)

(21) Appl. No.: 17/863,155

(22) Filed: Jul. 12, 2022

Related U.S. Application Data
(63) Continuation of application No. 15/711,903, filed on Sep. 21, 2017.
(60) Provisional application No. 62/407,952, filed on Oct. 13, 2016.

(51) Int. Cl. H04W 4/38; G06Q 10/06; H04W 12/06; H04W 4/02; H04W 4/06; F24F 11/30

(52) U.S. Cl. CPC H04W 4/38; G06Q 10/063114; H04W 12/06; H04W 4/025; H04W 4/06; F24F 11/30; G05B 2219/2614; F24F 11/58

(57) ABSTRACT

A control system for a heating, ventilation, and air conditioning (HVAC) system includes a service database including information associated with an HVAC unit. The service database includes data comprising a physical location of the HVAC unit and a service history for the HVAC unit. The control system also includes a user device communicatively coupled to the service database. The user device includes a controller having a memory and a processor. Additionally, the controller is configured to receive user input via the user device indicative of a service action performed on the HVAC unit, and update the service database such that the service history includes the service action.

### CROSS REFERENCE TO RELATED APPLICATION

This application is a continuation of U.S. patent application Ser. No. 15/711,903, filed Sep. 21, 2017, entitled “SYSTEMS AND METHODS FOR INTEGRATED APPLICATIONS OF HVAC SYSTEMS,” which claims priority to and the benefit of U.S. Provisional Patent Application No. 62/407,952, filed Oct. 13, 2016, entitled “PACKAGED ROOFTOP AIR CONDITIONER APP,” which are hereby incorporated by reference in their entireties for all purposes.

### BACKGROUND

The present disclosure relates generally to heating, ventilating, and air conditioning (HVAC) systems, and more particularly to systems and methods for integrated applications of the HVAC systems.

A wide range of applications exist for HVAC systems. For example, residential, light commercial, commercial, and industrial systems are used to control temperatures and air quality in residences and buildings. Generally, HVAC systems may circulate a fluid, such as a refrigerant, through a closed loop between an evaporator where the fluid absorbs heat and a condenser where the fluid releases heat. The fluid flowing within the closed loop is generally formulated to undergo phase changes within the normal operating temperatures and pressures of the system so that quantities of heat can be exchanged by virtue of the latent heat of vaporization of the fluid.

As such, HVAC systems employ many components to provide heated, cooled, and/or dehumidified air to conditioned environments. To maintain proper operation of the components, the HVAC systems may be inspected, maintained, and repaired by service technicians. However, when deployed at a building having an HVAC system, the service technician may not be able to access certain information about the HVAC system, service manuals associated with the HVAC system, or the like. As such, the service technician may be limited by the information that was brought to the building, thus negatively affecting performance of service actions. Accordingly, it may be desirable to provide more information about the HVAC systems to the service technicians and other users associated with the HVAC systems to enable more effective service actions to be performed.

### SUMMARY

In one embodiment of the present disclosure, a control system for a heating, ventilation, and air conditioning (HVAC) system includes a service database including information associated with an HVAC unit. The service database includes data comprising a physical location of the HVAC unit and a service history for the HVAC unit. The control system also includes a user device communicatively coupled to the service database. The user device includes a controller having a memory and a processor. Additionally, the controller is configured to receive user input via the user device indicative of a service action performed on the HVAC unit, and update the service database such that the service history includes the service action.

In another embodiment of the present disclosure, a control system for a heating, ventilation, and air conditioning (HVAC) system includes a service database including information associated with a plurality of HVAC units. The service database includes operating data of each HVAC unit of the plurality of HVAC units, respective physical locations of each HVAC unit of the plurality of HVAC units, and respective service histories of each HVAC unit of the plurality of HVAC units. The control system also includes a user device communicatively coupled to the service database. The user device includes a spatial positioning device and a controller having a memory and a processor. Additionally, the controller is configured to determine a location of the user device via the spatial positioning device. The controller is also configured to query the service database based on the location of the user device to determine an HVAC unit of the plurality of HVAC units that is within a threshold distance from the user device. The controller is further configured to receive user input indicative of a service action performed on the HVAC unit, and update the service database such that the respective service history of the HVAC unit includes the service action.

In a further embodiment of the present disclosure, a control system for a heating, ventilation, and air conditioning (HVAC) system includes a service database including information associated with a plurality of HVAC units. The service database includes a physical location of each HVAC unit of the plurality of HVAC units and a service history for each HVAC unit of the plurality of HVAC units. The control system also includes a user device communicatively coupled to the service database. The user device includes a controller having a memory and a processor. Additionally, the controller is configured to receive user input via the user device indicative of a set of search criteria including the physical location of each HVAC unit of the plurality of HVAC units and a parameter of each HVAC unit of the plurality of HVAC units. The controller is also configured to query the service database based on the set of search criteria to retrieve a list of HVAC units of the plurality of HVAC units that meet a threshold number of the set of search criteria. Further, the controller is configured to display the list of the HVAC units that meet the threshold number of the set of search criteria.

Other features and advantages of the present application will be apparent from the following, more detailed description of the embodiments, taken in conjunction with the accompanying drawings which illustrate, by way of example, the principles of the application.

### DRAWINGS

FIG. 1 is an illustration of an embodiment of a commercial or industrial HVAC system, in accordance with the present techniques;

FIG. 2 is an illustration of an embodiment of a packaged unit of the HVAC system, in accordance with the present techniques;

FIG. 3 is an illustration of an embodiment of a split system of the HVAC system, in accordance with the present techniques;

FIG. 4 is a schematic diagram of an embodiment of a refrigeration system of the HVAC system, in accordance with the present techniques;

FIG. 5 is a schematic diagram of an embodiment of an control system for the HVAC system, in accordance with the present techniques;

FIG. 6 is a schematic diagram of an embodiment of an integrated application for the HVAC system, in accordance with the present techniques

FIG. 7 is a schematic diagram of a service history module of the integrated application of FIG. 6, in accordance with the present techniques;

FIG. 8 is a schematic diagram of a reference manual module of the integrated application of FIG. 6, in accordance with the present techniques; and

FIG. 9 is a schematic diagram of a sales assistance module of the integrated application of FIG. 6, in accordance with the present techniques.

### DETAILED DESCRIPTION

The present disclosure is directed to heating, ventilation, and air conditioning (HVAC) systems and systems and methods for providing an integrated application for the same. In general, HVAC systems include multiple components that are designed to condition an interior space. To maintain performance of the HVAC systems, service technicians may examine the components of the HVAC systems, review operating data collected from the components, and/or review a service history of the components to identify one or more maintenance actions. To assist in performance of the maintenance actions, the service technicians may be provided with an integrated application for the HVAC systems via a user device. For example, the user device may be a cellular device or tablet having the integrated application may be installed thereon. The integrated application may include a plurality of interactive modules that may be useful to the service technicians performing the maintenance actions.

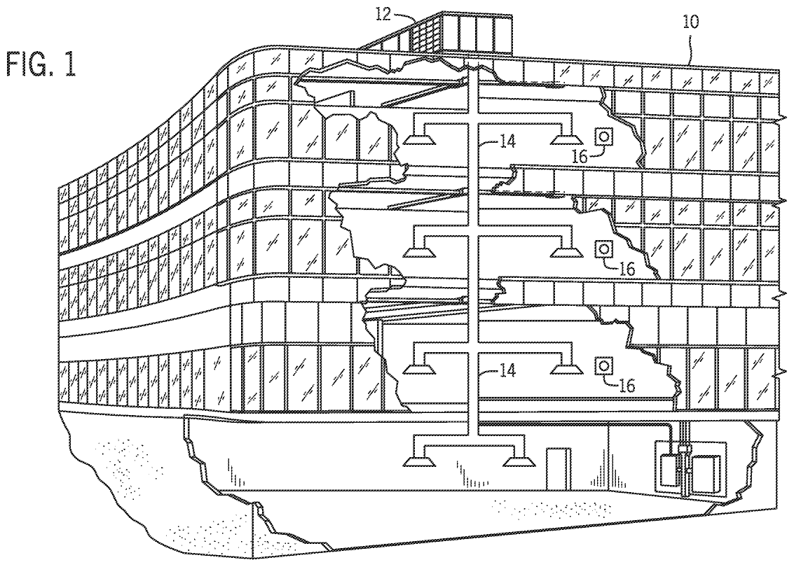

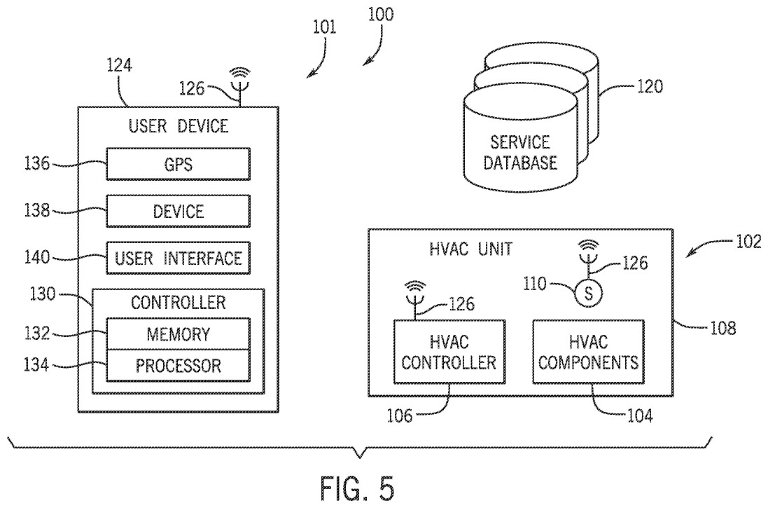

In some embodiments, users may provide log-in credentials to a log-in credentials module so that the integrated application may identify and authorize the user of the integrated application. Then, based on the authorizations of the identified user associated with the log-in credentials, the integrated application may allow access to a plurality of modules, such as a location module, an HVAC unit identification module, a service history module, an operating data module, a reference manual module, a contact information module, a part store module, a sales assistance module, or the like. These modules may retrieve information from and upload information to a service database, such that a comprehensive collection of data related to the HVAC systems is maintained for later access by the user or other users of the integrated application. Thus, users such as the service technicians may be able to access relevant information for any HVAC system. Detailed information related to operation of the HVAC systems is discussed below with reference to FIGS. 1-4. Additionally, further details related to the integrated application for HVAC systems is discussed with reference to FIGS. 5-9 below.

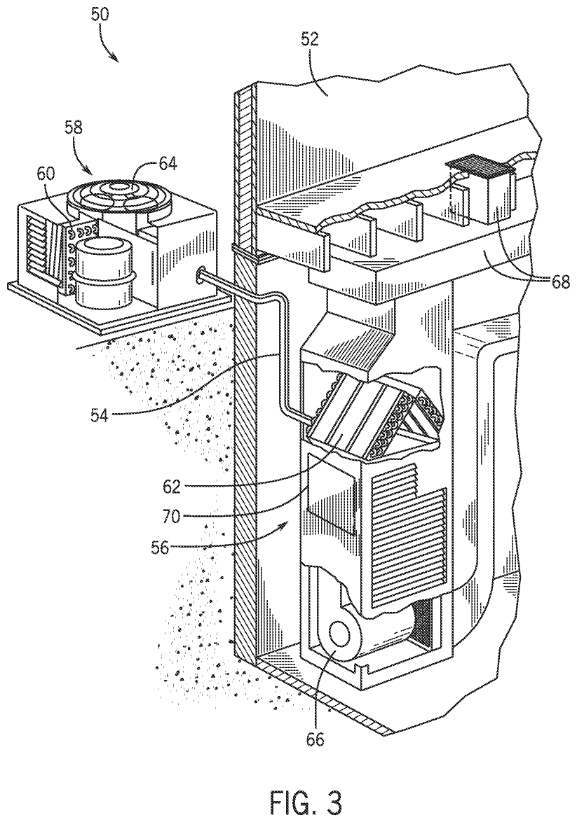

Turning now to the drawings, FIG. 1 illustrates a heating, ventilating, and air conditioning (HVAC) system for building environmental management that may employ one or more HVAC units. In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

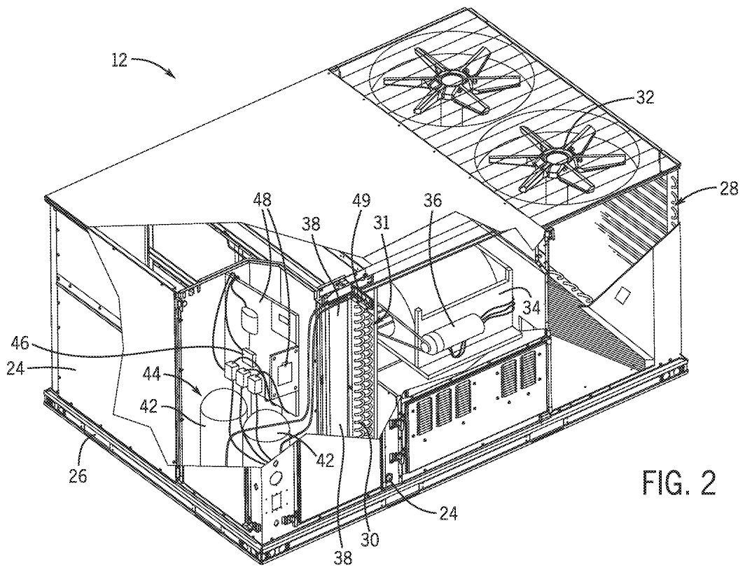

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant (for example, R-410A, steam, or water) through the heat exchangers 28 and 30. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms (one or more being referred to herein separately or collectively as the control device 16). The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant (which may be expanded by an expansion device, not shown) and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat (plus a small amount), the residential heating and cooling system 50 may become operative to refrigerate additional air for circulation through the residence 52. When the temperature reaches the set point (minus a small amount), the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over outdoor the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger (that is, separate from heat exchanger 62), such that air directed by the blower 66 passes over the tubes or pipes and extracts heat from the combustion products. The heated air may then be routed from the furnace system 70 to the ductwork 68 for heating the residence 52.

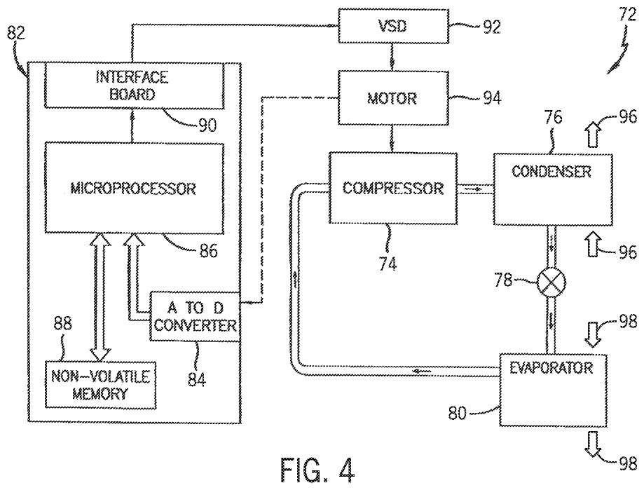

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 38 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

As discussed above, the present techniques are directed to an integrated application for a user device for accessing and providing information related to HVAC systems, such as identification data, location data, HVAC unit identification data, service history data, operating data, reference manuals, contact information, part store data, sales assistance data, and other suitable types of data. The information may be related to any of the systems discussed above, such as the HVAC unit 12, the cooling system 50, the vapor compression system 72, another HVAC system, or a combination thereof. Indeed, the integrated application may enable service technicians to identify a data entry in a service database for a specific HVAC unit based on a serial number of the HVAC unit, a physical location of the HVAC unit, or the like. Then, the service technician may access the service database to retrieve a service history related to the HVAC unit, operating data related to the HVAC unit, reference manuals associated with the HVAC unit, contact information for contacting users associated with the HVAC unit, a part ordering store for ordering parts associated with the HVAC unit, or any other suitable and relevant information for interacting with the HVAC unit. Additionally, the types of information provided to the service technician may be based on authorizations provided to the service technician, such that each service technician may be enabled to receive information related to each product for which they are certified to service. Moreover, the user may be identified as a salesperson who is authorized to use a sales assistance module of the integrated application to identify HVAC units that may be nearing a service limit. In this way, salespeople may use the integrated application to contact building managers or owners associated with the identified HVAC units to explore sales opportunities. As such, the integrated application may provide interactive information to multiple users to maintain an updated service database, which other integrated applications may access to enable rapid and informed performance of maintenance actions and sale opportunities. Indeed, as discussed below, various components and modules interact in various ways to enable the integrated application to consolidate multiple forms of information through a single, accessible venue.

FIG. 5 is a schematic diagram illustrating an embodiment of an HVAC system 100 having a control system 101 and an HVAC unit 102. In some embodiments, the HVAC system 100 is part of the HVAC unit 12 discussed above, the residential heating and cooling system 50 discussed above, and/or other HVAC systems. Moreover, the HVAC system 100 may perform all or a combination of heating, ventilation, and/or air conditioning functions. As shown, HVAC components 104 and an HVAC controller 106 are disposed within an enclosure 108 of the HVAC unit 102. However, the HVAC components 104 and the HVAC controller 106 may be disposed outside of the enclosure 108 in certain embodiments.

The HVAC components 104 may include any of the components discussed above, such as the heat exchangers 28, 30, the fans 32, the compressors 42, or the like. Moreover, a sensor 110 may be disposed on or within a threshold distance of the HVAC components 104 to transmit signals indicative of operating parameters of the HVAC components 104. The threshold distance may be individually specified for each sensor or type of sensor. For example, the sensor 110 may include a temperature sensor, a pressure sensor, a flow sensor, an electricity meter, a voltage sensor, a contact sensor, a thermostat, a humidistat, or any other suitable sensor included in the HVAC system 100. As such, the sensor 110 may transmit signals indicative of operating data of the HVAC system 100, such as temperatures, pressures, flows, voltages, contact, humidity, or the like. In some embodiments, the HVAC controller 106 may receive the signals from the sensor 110 indicative of the operating data. Based on the operating data, the HVAC controller 106 may control operation of the HVAC components 104 to condition the interior space.

The HVAC controller 106 may transmit or upload the operating data to a service database 120. The service database 120 may be part of the control system 101 for the HVAC system 100. In some embodiments, the service database 120 may include multiple databases disposed in multiple locations. In some embodiments, the service database 120 is part of a cloud-computing system. The service database 120 may include data or information regarding the HVAC unit 102 and/or other HVAC units. For example, the service database 120 may include data regarding identification data of the HVAC unit 102 (e.g., serial number, bar code, associated Quick Response (QR) code®, etc.), a service history of the HVAC unit 102, the operating data received from the sensor 110, reference and/or instruction manuals associated with the HVAC unit 102 (e.g., technical reference manual, startup guide, wiring diagrams, engineering guide, etc.), contact information associated with the HVAC unit 102, a listing of the HVAC components 104 or configurations of the HVAC unit 102, sales information associated with the HVAC unit 102 (e.g., unit age, unit service life, contractor, engineer, owner, etc.), and the like.

In some embodiments, a user may access the service database 120 via a user device 124. The user device 124 may be part of the control system 101 for the HVAC system 100. Moreover, the user device 124 may be used to communicate with and/or control the HVAC unit 102 directly. The user device 124 may be a portable device or a stationary device, such as a cellular phone, a tablet, a smart watch, a pair of smart glasses, a laptop computer, or a desktop computer. As shown, the user device 124, the HVAC unit 102, and the sensor 110 may wirelessly communicate to one another and access the service database 120 though a wireless connection 126. The wireless connection 126 may be a connection through a cellular network, radio transmission, Bluetooth® Low Energy, ZigBee®, WiFi®, or another type of wireless communication. Moreover, in some embodiments, the user device 124, the HVAC unit 102, and the sensor 110 may include a wired connection to facilitate communication therebetween.

The user device 124 may include multiple components to enable the user to operate the integrated application to access collected information associated with the HVAC unit 102. For example, as shown, the user device 124 may include a controller 130 having a memory 132 and a processor 134. The controller 130 may also include one or more storage devices and/or other suitable components. The processor 134 may be used to execute software, such as software for controlling the user device 124, operating the integrated application, and so forth. Moreover, the processor 134 may include multiple microprocessors, one or more “general-purpose” microprocessors, one or more special-purpose microprocessors, and/or one or more application specific integrated circuits (ASICS), or some combination thereof. For example, the processor 134 may include one or more reduced instruction set (RISC) processors.

The memory 132 may include a volatile memory, such as random access memory (RAM), and/or a nonvolatile memory, such as read-only memory (ROM). The memory 132 may store a variety of information that may be used for various purposes. For example, the memory 132 may store processor-executable instructions (e.g., firmware or software) for the processor 134 to execute, such as instructions for operating the integrated application. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the HVAC system 100, software or firmware for controlling the integrated application, etc.), and any other suitable data. Moreover, in some embodiments, the service database 120 may be disposed within the memory 132 or the storage device(s).

Additionally, the user device 124 may include a spatial locating device, such as a global positioning system (GPS) 136. The GPS 136 may communicate with one or more satellites to enable the user device 124 to determine GPS coordinates such as a latitude, longitude, and/or an elevation of the user device 124 relative to the Earth. Moreover, the user device 124 may additionally or alternatively include any other suitable spatial locating device, such as a ground-based radar system, a dead-reckoning system, a WiFi®-router based triangulation system, a magnetic positioning system, or any other suitable system that can determine a location of the user device 124. In this manner, the user device 124 may be location-enabled.

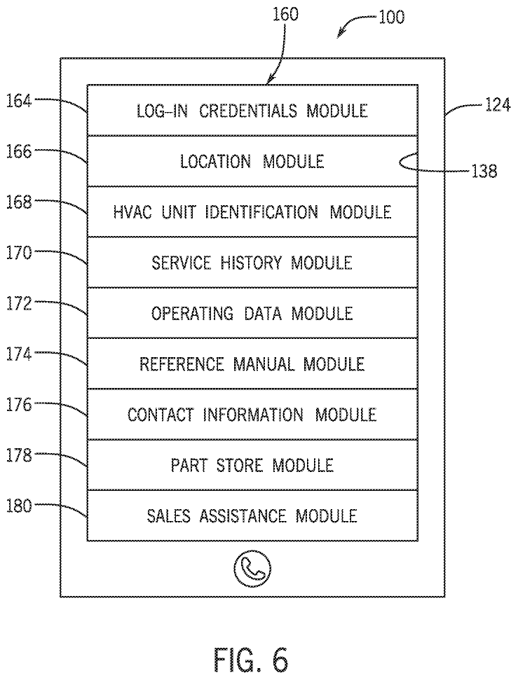

Further, the controller 130 may use the location of the user device 124 to determine whether one or more HVAC units 102 are within a threshold distance from the user device. In some embodiments, the controller 130 may query the service database 120 to retrieve a list of the HVAC units 102 that are within the threshold distance from the user device 124. The threshold distance may be user-set at any suitable distance, such as 1 meter, 2 meters, 3 meters, 4 meters, 5 meters, 6 meters, 7 meters, 8 meters, 9 meters, 10 meters, or more. In some embodiments, the threshold distance may be limited based on a resolution of the included spatial locating device(s). Additionally, the threshold distance may be stored within the memory 132. Moreover, the controller 130 may determine that the user device is within the threshold distance of the HVAC unit 12 if the user device 124 is able to scan a barcode or other identification information from the HVAC unit, or if user input or other detection devices indicate that the user device 124 is within a same buiilding as the HVAC unit 102. Additional uses of the location of the user device 124 will be discussed below with reference to FIGS. 6-9.

The user device 124 may also include a display 138 communicatively coupled to the controller 130. The display 138 may depict visualizations associated with software or executable code stored on the memory 132. Additionally, the display 138 may be a touch display for receiving user input, or any suitable type of display, such as a liquid crystal display (LCD), plasma display, or an organic light emitting diode (OLED) display. The display 138 may present a visualization of the integrated application to the user, so that the user may provide user input through the display 138 to the controller 130. As such, the display 138 may be coupled with a touch-sensitive mechanism to function as a user interface 140. However, in some embodiments, the user interface 140 may be another component, such as a keyboard, a mouse, and/or a speech recognition device, etc.

The user device 124 may additionally or alternatively include any other suitable components and/or may include a portion of the aforementioned components. For example, the user device 124 may also include input/output ports for connecting additional devices thereto, audio devices for outputting audible sounds or instructions, a camera for capturing visual or IR images, or any other suitable components for presenting and operating the integrated application.

FIG. 6 is a schematic diagram of an integrated application 160 displayed on the user device 124. In some embodiments, the integrated application 160 is displayed on the display 138 of the user device 124. While the following discussion relates to embodiments in which the user device 124 is a cellular phone, it is to be understood that any other suitable device having a display may be employed by the techniques discussed herein. Moreover, based on received user input (e.g., touch, verbal input, etc.) and/or a location of the user device 124, the integrated application 160 may display various interactive modules and information related to the HVAC system 100 and HVAC units 102 therein. The integrated application 160 may combine multiple interfaces and sources of information within a single accessible and navigational application to enable users to perform desired functions within a single program. In this manner, the integrated application 160 may increase the amount of information and the reliability of information that users of the integrated application 160 may access, as compared to the amount of information available to users who navigate through multiple websites and platforms to perform multiple actions, or arrive at job sites without internet access and/or without printed or downloaded versions of desired information.

Looking now to modules that may be included in the integrated application 160, as shown, the integrated application 160 may include a log-in credentials module 164. By selecting the log-in credentials module 164 (e.g., via the user interface 140), the user may be instructed to input log-in credentials to unlock or access other functions and modules of the integrated application 160. For example, the user may input log-in credentials such as a user name and a password, a software key, a fingerprint scan, an employee identification number, or the like. Additionally, in some embodiments, the user may be able to create a new account or select to proceed in a guest or demonstration mode of the integrated application 160. In such embodiments, the guest or demonstration mode may enable the user to view a selected portion of modules or selected functions of the modules.

Based on the log-in credentials provided by the user, the integrated application 160 may determine a user type of the user. Based on the user type, the integrated application 160 may unlock or lock certain functions or modules of the integrated application 160. User types may be denominated between any suitable titles, such as an end user (e.g., a residence owner, a building manager), a service technician, a distributor (e.g., salesperson), or the like. For example, if the log-in credentials indicate that the user is an end user, the integrated application 160 may enable the end user to view certain types of data, such as a service history of the HVAC system 100 and operating data of the HVAC system 100. Additionally, if the log-in credentials validate that the user is a service technician, the integrated application 160 may enable the service technician to view certain types of data, such as the operating data, and edit other types of data, such as the service history of the HVAC system 100. Indeed, the various access provided to each user type may be set by the creator of the integrated application 160 to suit any desired set of users.

Moreover, the log-in credentials may indicate types of products (e.g., channels) that the service technician is authorized to access. For example, if the service technician has provided product keys for a first type of product and a second type of product, the service technician may interact with data entries and modules related to both the first and the second types of products. However, if the service technician has not entered a product key for a third type of product, the integrated application 160 may not enable the service technician to interact with or view data indicative of the third type of product. In this manner, the log-in credentials module 164 may enable the integrated application to provide selective access to various types of information to the users based on their respective authorizations.

Additionally, the integrated application 160 may include a location module 166. The location module 166 may be selected by a user to instruct the integrated application 160 to determine a location of the user device 124 (e.g., based on the GPS included in the user device 124). Then, based on the location of the user device 124, the integrated application 160 may perform multiple location-based actions, such as retrieving and display a list of HVAC units 102 that are within the threshold distance of the user device 124 from the service database 120. Additionally, the location module 166 or a settings page of the integrated application 160 may enable the user to input a user preference for the threshold distance (e.g., 1 meter, 5 meters, 10 meters, 50 meters, etc.). Moreover, based on the location of the user device 124, the integrated application 160 may tag interactions with the integrated application 160 with a current location of the user device. Additionally, the location module 166 may include integrated mapping services to enable the user to navigate from the location of the user device to a location of an HVAC unit 102 (e.g., upon user input indicative of a desire to view directions to the HVAC unit 102). More details related to the location enabled aspects of the integrated application 160 will be included below with discussions of additional modules.

Additionally, the integrated application 160 may include an HVAC unit identification module 168. In such embodiments, the HVAC unit identification module 168 may enable the user to rapidly identify the HVAC unit 102 in the field based on identification data of the HVAC unit 102. For example, the HVAC unit 102 may have a serial number, a bar code, a QR code®, or another suitable identification function. The user may input the identification data to the HVAC unit identification module 168, which then queries the service database 120 to identify the HVAC unit 102. In such embodiments, the user input may be provided as a text string, an image, an audio recording, or another suitable input. By identifying the HVAC unit 102 in-situ, the integrated application 160 enables the user to access and retrieve unit-specific information. Moreover, in some embodiments, if the service database 120 does not include an entry for the HVAC unit 102 (e.g., if the HVAC unit 102 is newly installed or serviced for the first time), the integrated application 160 may input the identification data for the HVAC unit 102 into the service database, as well as a location of the HVAC unit 102, so that subsequent user interactions with the HVAC unit 102 may be logged within the service database 120.

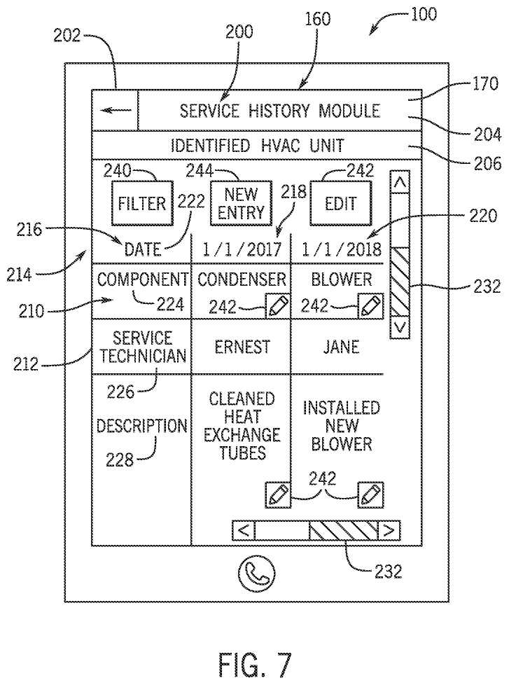

Moreover, in certain embodiments, the integrated application 160 includes a service history module 170. The service history module 170 may retrieve a service history (e.g., service history data) for the HVAC unit 102 based on the identification of the HVAC unit 102 from the service database 120. Additionally, if the HVAC unit 102 is not already included in the service database 120, the service history module 170 may open a new file or entry for the new or previously unrecorded HVAC unit 102 based on the new identification information. Thus, via the service history module 170, the integrated application 160 may be relied upon by the user to keep a log of the HVAC units 102. Moreover, the service history module 170 may be employed to track a log of service actions (e.g., maintenance, installation, startup operations, etc.) performed on the HVAC system 100 for storage in the service database 120. An example of the service history module 170 is discussed below with reference to FIG. 7.

Additionally, the integrated application 160 may include an operating data module 172. The operating data module 172 may retrieve, combine, and/or analyze the operating data that the HVAC controller 106 receives from the sensor 110. The operating data module 172 may therefore present trends, charts, spreadsheets, and the like indicative of the operation of the HVAC system 100. Moreover, the operating data module 172 may present the operating data organized in various manners, such as hierarchical organizations, component-based organizations, parameter-based organizations (e.g., temperatures, pressures, flow rates), or any other suitable organization. The operating data module 172 may also present alerts from the HVAC controller 106 indicative of a parameter being out of an expected range, or the operating data module 172 may generate the alerts itself. Moreover, in certain embodiments, the operating data module 172 may push notifications through the integrated application 160 to the user to inform the users of the alerts. In some embodiments, the user may interact with the alert to initiate a control action. For example, if the user is authorized as a service technician, the user may instruct a compressor having a compression ratio below an expected range to shut down until the service technician is able to service the HVAC system 100. Moreover, if the user is identified as an end user, the operating data module 172 may present various suitable (e.g., controller-determined, appropriate) control actions to the user for user selection, thus enabling the user to authorize any suitable control action. In some embodiments, the suitable control actions may include shutting down the HVAC system 100, shutting down a portion of the HVAC system 100, transmitting alerts to other users (e.g., service technicians) associated with the HVAC system 100, and the like. In some embodiments, service requests/tickets are automatically generated by the operating data module 172 in response to user selection of a request to generate service requests/tickets, such that push notifications or alerts are transmitted to associated service technicians. Additionally, in some embodiments, the end user may perform some service actions, such as opening a service ticket.

Moreover, the integrated application 160 may include a reference manual module 174. The reference manual module 174 may be accessed by the user to identify operating and maintenance guides, installation guides, publications, discussion boards, or the like that are associated with the identified HVAC unit 102. For example, after the HVAC unit 102 is identified via the HVAC unit identification module 168, the reference manual module 174 may automatically retrieve the related documents from the service database 120. In some embodiments, the reference manual module 174 may include a checklist or a workflow for a maintenance action the service technician is to perform during a visit to the HVAC unit 102. In such embodiments, the service technician may provide input to the checklist or the workflow to indicate when each step of the workflow is complete. A list of the completed steps may be copied to the service history module 170 entry for this visit to the HVAC unit 102. As such, the reference manual module 174 may operate as an automatically updated reference repository to enable service technicians to access updated reference documents and workflows for the HVAC system 100.

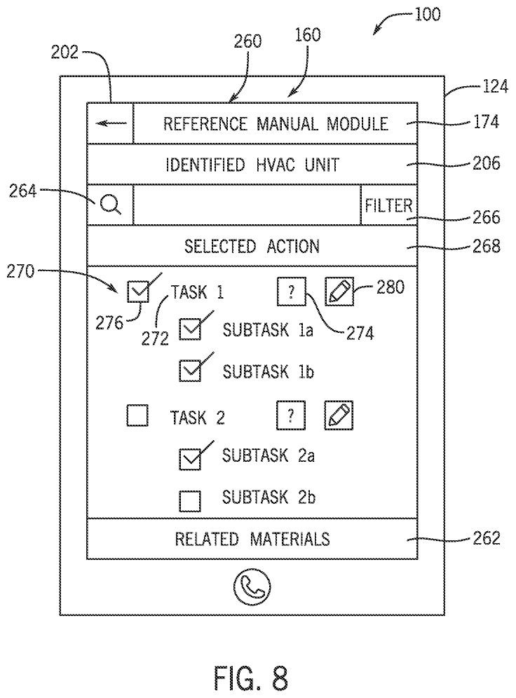

Moreover, in some embodiments, the reference manual module 174 may retrieve service history log entry for a requested operation that was performed on a similar HVAC unit 102, such that the service technician may reference previously completed operations. For example, if the service technician is cleaning a certain component, the service technician may request that the reference manual module 174 retrieves a list of other instances that the certain component was cleaned from the service database 120, and present the descriptions provided by those service technicians on the user device 124. An example of the reference manual module 174 is discussed below with reference to FIG. 8.

In some embodiments, the integrated application 160 also includes a contact information module 176. The user may select the contact information module 176 to display a menu indicative of people or businesses associated with the HVAC system 100, and methods by which to contact the people or businesses. For example, the contact information may include a list of end users, service technicians, and/or distributors, as well as corresponding email addresses and/or corresponding phone numbers for the users. For example, upon user selection of a phone number corresponding with a building manager, the user may initiate a phone call with the building manager through the integrated application 160. Additionally, upon selection of an email address corresponding to the building manager, the user may initiate an email to the building manager through the integrated application 160. In some embodiments, call, text, and email functionalities are embedded within the integrated application 160. Additionally, call, text, and email functionalities may be parallel with the integrated application 160, such that interaction with the contact information opens another application of the user device (e.g., a calling application, an emailing application). Moreover, after installation of the integrated application 160, the user of the user device 124 may be prompted to provide contact information for himself or herself to the contact information module 176. The contact information module 176 may store the contact information within the service database 120, such that other users may retrieve the contact information therefrom.

Additionally, the integrated application 160 may include a part store module 178. The part store module 178 may enable the user to view and interact with an online store having equipment that is compatible with the identified HVAC unit 102. For example, if the identification module 168 identifies that the HVAC unit is a first type of HVAC unit, the part store module 178 may selectively display components (e.g., parts, tools, equipment, etc.) that are compatible with the first type of HVAC unit 102. Through the part store module 178, the user may select and purchase parts. Moreover, in some embodiments, the part store module 178 may enable the user to order the parts to be sent to the identified location of the user device 124 (e.g., building, street address), such that a service technician may later visit the location to install the part or use the inspection device. Additionally, in some embodiments, the part store module 178 may enable the user to set a default mailing address to a work address associated with the user. The integrated application 160 may therefore provide a specialized store experience to the user based on the identified HVAC unit 102 within the integrated application 160.

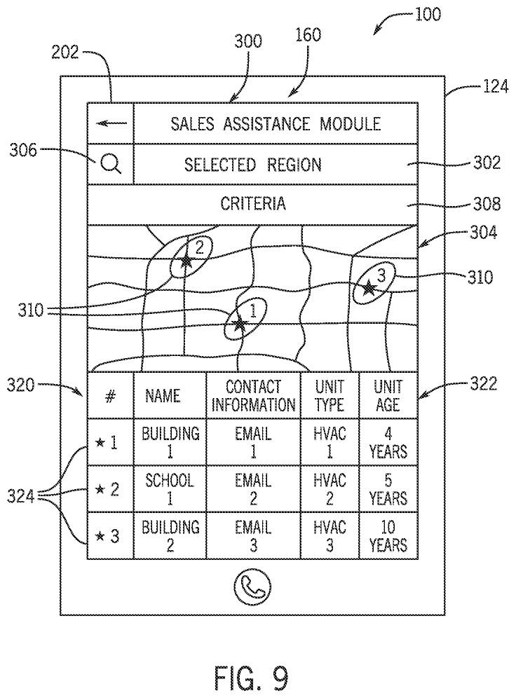

Further, the integrated application 160 may include a sales assistance module 180. The sales assistance module 180 may be activated, revealed, or otherwise made available to a user after the user is authenticated as a distributor (e.g., or a service technician). In certain embodiments, the user may be provided with a software key that permits the distributor to download a version of the integrated application 160 having the sales assistance module 180. The sales assistance module 180 may present a geographical map having indicators for HVAC units 102 within the user's sale territory, geographical region, threshold distance, or the like. Upon interaction with the sales assistance module 180, the user may view HVAC units within the threshold distance that meet filtered criteria. For example, the user may request to see HVAC units that have not been serviced within a threshold amount of time, that have an age greater than an age threshold, that have an expected usable life lower than a life threshold, that have more than a threshold number of service tickets open, that are not already associated with a distributor, that include certain outdated components or modules, or any other suitable criteria. In some embodiments, the end users of the HVAC units may opt out of being presented on this list. However, by including HVAC units 102 within the sales assistance module 180, the integrated application 160 enables the user to provide relevant marketing materials, advertisements, and the like to the end users of the HVAC units 102. An example of the sales assistance module 180 is discussed below with reference to FIG. 9.

Now looking in more detail at certain modules, FIG. 7 is a schematic diagram of a screen overlay 200 of the service history module 170 of the integrated application 160 displayed on the user device 124. It is to be understood that the below discussion of the screen overlay 200 is intended as one embodiment of multiple embodiments by which the integrated application 160 may present the service history module 170 to the user. In some embodiments, the screen overlay 200 is presented on the user device 124 in response to user selection of the service history module 170 from a displayed list of modules or functions of the integrated application 160. Further, to return to the displayed list of modules, the screen overlay 200 may include a return function 202. Upon user selection of the return function 202, the integrated application 160 may display a previously loaded screen, overlay a list of the modules over the current screen overlay 200, or otherwise enable the user to navigate through the integrated application 160. Moreover, the screen overlay 200 may include other suitable navigation functions, virtual buttons, or the like, such as a button for returning to a bookmarked place in the integrated application 160, a button for storing and accessing bookmarked pages within the integrated application 160, or the like.

As shown, the screen overlay 200 of the service history module 170 may display near a top portion 204 of the display 138 that the integrated application 160 has been navigated to the service history module 170. Additionally, the screen overlay 200 may present an identified HVAC unit indicator 206. In some embodiments, the identified HVAC unit indicator 206 displays identification information associated with a selected HVAC unit 102. In some embodiments, the identification information may be a location of the identified HVAC unit, a serial number of the identified HVAC unit, a name or product associated with the identified HVAC unit, or the like. As previously discussed, the identified HVAC unit 102 may be determined by the HVAC unit identification module 168. In embodiments in which the user navigates to the service history module 170 before an HVAC unit 102 is identified, the user may select the identified HVAC unit indicator 206 to cause the integrated application 160 to load the HVAC unit identification module 168. Then, after the HVAC unit 102 has been identified (e.g., based on GPS, bar code, etc.), the integrated application 160 may automatically close the HVAC unit identification module 168, return to the service history module 170, and populate the identified HVAC unit indicator 206 with identification information related to the identified HVAC unit 102.

Moreover, in a middle portion 210 of the screen overlay 200, the service history module 170 may include service history data 212. The integrated application 160 may retrieve the service history data 212 from the service database 120 based on the identified HVAC unit 102. The service history data 212 may be in any suitable form for displaying data to the user, such as a chart, an image, or a spreadsheet. As shown, the service history data 212 may include a spreadsheet having rows 214 and columns 216 to display data entries of the service history data 212, such as a first entry 218 and a second entry 220 for the identified HVAC unit 102. As shown, the leftmost column 216 may include identifiers (e.g., data tags, titles, etc.) for the entries 218, 220. For example, the identifiers may include a date identifier 222, a component identifier 224, a service technician identifier 226, a description identifier 228, or any other suitable identifier to correspond with other information related to the integrated application 160. The first entry 218 and the second entry 220 may each include corresponding data points that align with the identifiers. For example, as noted by the first entry 218, upon visiting the HVAC system 100 on Jan. 1, 2017, a service technician Ernest may have cleaned the heat exchange tubes of the condenser. Additionally, as noted by the second entry 220, upon visiting the HVAC system 100 on Jan. 1, 2018, a service technician Jane may have installed a new blower. As such, the service history data 212 may represent a log of service actions (e.g., maintenance, installations, etc.) associated with the HVAC system 100.

Moreover, to navigate through the service history data 212, the screen overlay 200 may include a horizontal scrolling function 230 and/or a vertical scrolling function 232. By interacting with the scrolling functions 230, 232, the user may view more entries of the service history data 212 and/or more identifiers of the service history data 212. As such, the amount of information available to the user is not limited by a form factor (e.g., physical form factor, screen size) of the user device 124. Additionally, to tailor the entries or the components of the entries that the user views, the user may interact with a filter function 240. The filter function 240 may present filtering options to the user, such that the user may select to view entries that meet selected criteria. For example, the user may filter the service history data 212 to display entries that correspond to certain criteria, such as service history data related to a certain component, a certain technician, a certain date, and/or a certain range of dates, or the like.

Additionally, to edit the service history data, the screen overlay 200 may include one or more edit functions 242. In some embodiments, the edit function 242 is included below each data entry or within each cell, while in other embodiments, a single edit function 242 may be included on the screen overlay 200. Upon interaction with the edit function 242, the user may be able to change data within cells of the service history data 212. In some embodiments, the integrated application 160 may enable the user to perform a certain touch action (e.g., double tap, one long tap, etc.) to initiate an edit mode for the service history data 212. In some embodiments, only service history data 212 associated with the description identifier 228 may be edited from the user device.

In some embodiments, the user may interact with a new entry function 244 to cause the service history module 170 to open a new entry (e.g., column) in the service history data 212. The user may open a new entry in the service history data 212 to log a description of service actions or observations that the user has performed for the HVAC unit 102. Indeed, the service history module 170 may also implement a camera of the user device 124 upon user selection of a request to take an image or video of the HVAC unit 102. Then, the service history module 170 may store captured images or videos within the service history data 212.

In some embodiments in which a user is a service technician implementing a service action, all or a portion of the information included in the new entry of the service history data 212 may be automatically populated based on the user device 124 associated with the user, or may be populated based on user interaction. For example, service history data 212 for the new entry may automatically include a timestamp based on a stored date and time of the user device 124, and/or may automatically include a service technician name or identification information based on the log-in credentials provided to the user device 124. In embodiments in which a service ticket was opened (e.g., via the operating data module 172), data corresponding with the component identifier 224 and other identifiers (e.g., description of perceived issue) may be automatically populated based on data included in the service ticket.

Further, user access to the functions of the service history module 170 may be limited or controlled based on the authorizations of the user that was identified by the log-in credentials module 164. For example, if the integrated application 160 identifies the user as an end user, the service history module 170 may selectively enable the user to view the service history data 212, with the scrolling functions 230, 232 and the filter function 240 enabled. In such embodiments, the edit function 242 and the new entry function 244 may be grayed out, deactivated, hidden or the like. However, in some embodiments, the end user may be able to use the new entry function 244 to open a new service ticket in the service history module 170, which is then transmitted to user devices 124 to alert service technicians of the new service ticket.

Additionally, if the integrated application 160 identifies the user as a service technician, a certain portion of the functions of the service history module 170 may be enabled. For example, the service technician may scroll, filter, edit, and create new entries within the service history data 212 via the corresponding functions. In some embodiments, the service technician may be selectively able to view and/or edit previous service history data 212 entries that are associated with himself or herself, or associated with a company associated with the service technician. Additionally, the service technician may be selectively able to create new entries for types of components for which the service technician is certified (e.g., based on certifications of the service technician stored in the service database 120). Moreover, in some embodiments, the service technician may be selectively able to view service history data 212 that is associated with a brand of units for which the service technician is authorized, such that the service history module 170 pre-filters the service history data 212 based on the identified service technician. In this manner, the service history module 170 enables the user to log service actions easily within the integrated application 160, such that the service actions are stored within the service database 120 and readily available to other users of the integrated application 160. It is to be understood that all or only a portion of the above noted functions of the service history module 170 may be included in the integrated application 160. Moreover, each function of the integrated application 160 may be combined, resized, changed in order, associated with other modules, or the like.

FIG. 8 is a schematic diagram of a screen overlay 260 of the reference manual module 174 of the integrated application 160 displayed on the user device 124. It is to be understood that the below discussion of the screen overlay 260 is intended as one embodiment of multiple embodiments by which the integrated application 160 may present the reference manual module 174 to the user. In some embodiments, the screen overlay 260 is presented on the user device 124 in response to user selection of the reference manual module 174 from a displayed list of modules or functions of the integrated application 160. As discussed above with reference to FIG. 7, the screen overlay 260 may also include the return function 202 and the identified HVAC unit indicator 206. Similarly, in embodiments in which the user navigates to the reference manual module 174 before the HVAC unit 102 is identified, the user may select the identified HVAC unit indicator 206 to cause the integrated application 160 to load the HVAC unit identification module 168 and identify the HVAC unit 102.

As previously discussed, the reference manual module 174 may include reference manuals such as maintenance guides, installation guides, publications, discussion boards, instructional videos, or the like to assist a user, such as the service technician, in completing service actions. The reference manual module 174 may automatically populate the screen overlay 260 with a list of related materials that are associated with the identified HVAC unit represented by the identified HVAC unit indicator 206. For example, if the identified HVAC unit 102 is associated with a certain brand and model number of a rooftop unit, the reference manual module 174 may display a list of materials that correspond with the certain brand and/or module number of the rooftop unit. Moreover, the user may use a search functionality 264 and a filter functionality 266 to parse the results of the automatic population of manuals. The user may view and interact with the reference manuals to learn more about each service action that the user is to perform while deployed at the HVAC unit 102.

In certain embodiments, the user may interact with the reference manuals to select a certain action within the reference manuals. In some embodiments, the reference manuals include interactive workflows for the technician to follow. For example, the user may select to perform a blower replacement for the HVAC system 100 from a list of interactive actions. Then a selected action indicator 268 may display the name of the selected action (e.g., “blower replacement”). In some embodiments, the reference manual module 174 may present an interactive workflow 270 for performing the selected action. For example, for each task, the interactive workflow 270 may include task names 272, information boxes 274 related to the task names 272, and check boxes for indicating that the task denoted by the task name 272 is complete. In some embodiments, the user may select the information box 274 to receive more information (e.g. reference manuals, instruction videos, etc.) related to performing the task. Additionally, the user may interact with the check boxes 276 to indicate that the task has been completed (e.g., provide user input indicative of completion of the task). In some embodiments, a hierarchical ordering of tasks and sub tasks may be included in the interactive workflow 270. In such embodiments, the user may interact with the check boxes 276 of the subtasks to indicate that the subtask are complete, and when each subtask has been checked, the check box 276 for the task having each of the completed subtasks may be automatically marked as a completed task (e.g., checked).

Moreover, in some embodiments, the reference manual module 174 includes an edit function 280 to enable the user to enter a description associated with performance of a certain task. For example, if the user is viewing steps within a reference manual, the user may interact with the edit function 280 to log an account of service actions performed on the HVAC unit 102. The log may be automatically entered into the service history data 212 and/or the service database 120. Moreover, in embodiments having the interactive workflow 270, each task and/or subtask may include an edit function 280 to enable the user to enter the log of the service actions. As such, the reference manual module 174 may generate an entry in the service history data 212 (FIG. 7) for the completed interactive workflow 270. Additionally, in embodiments in which the interactive workflow 270 is not included, the screen overlay 260 may alternatively include a display of a non-interactive workflow, an instructional video, or the like to enable the user to receive up to date instructions for performing the selected action shown by the selected action indicator 268.

Additionally, the reference manual module 174 may include a related materials indicator 282. In some embodiments, the related materials indicator 282 is displayed beneath the interactive workflow 270 as shown; however, the related materials indicator 282 may be placed in another suitable location on the screen overlay 260. The user may interact with the related materials indicator 282 to select another reference manual, video, or information source related to the selected action shown by the selected action indicator 268. For example, if the interactive workflow 270 is related to performing a startup on the selected HVAC unit 102, the related materials may include other reference documents for performing the startup. Indeed, in some embodiments, the related materials indicator 282 may be a tray function containing icons corresponding to the other related materials. Then, upon user selection of the icons, the screen overlay 260 may be regenerated to include a display of the selected related material. In some embodiments, the related materials indicator may additionally or alternatively display a portion of the information contained in the related materials, such that the user may view the interactive workflow or other instructions, as well as another reference document simultaneously. It is to be understood that all or only a portion of the above noted functions of the reference manual module 174 may be included in the integrated application 160. Moreover, each function of the integrated application 160 may be combined, resized, changed in order, associated with other modules, or the like.

FIG. 9 is a schematic diagram of an embodiment of a screen overlay 300 of the sales assistance module 180 of the integrated application 160 displayed on the user device 124. It is to be understood that the below discussion of the screen overlay 300 is intended as one embodiment of multiple embodiments by which the integrated application 160 may present the sales assistance module 180 to the user. In some embodiments, the screen overlay 300 is presented on the user device 124 in response to user selection of the sales assistance module 180 from a displayed list of modules or functions of the integrated application 160. As discussed above with reference to FIG. 7, the screen overlay 300 may also include the return function 202 or other suitable navigation functions.

As discussed above, the sales assistance module 180 may enable a user such as a distributor for HVAC units and parts to identify end users who may desire to purchase updated components or review advertising materials. For example, the distributor may sell parts and/or services within a certain geographical region, city, county, state, or the like. Thus, the sales assistance module 180 may include a selected region identifier 302 to adjust a view of a map portion 304. The map portion 304 may be a displayed image from a mapping service program, satellite imagery, schematic imagery, or any other suitable visualization of a geographic area. By inputting various selected regions 302, the map portion 304 may change to correspond to a visual representation of the selected region corresponding to the selected region identifier 302. To enable the user to search for various selected regions, the screen overlay 300 may also include a search function 306.

Based on user input to the search function 306, the sales assistance module 180 may query the service database 120 to determine whether one or more HVAC units 102 meet a specified set of criteria 308 or a threshold number of the set of criteria 308. The user may specify the criteria 308 based on information (e.g., parameters) available within the service database 120, such as model of HVAC unit, age of HVAC unit, location of HVAC unit, owner of HVAC unit 102, and the like. In some embodiments, the criteria 308 at least include the location of the HVAC unit 102 and one other parameter of the HVAC unit 102. The criteria 308 may be selected individually or in combination, such that the sales assistance module 180 may query the service database 120 based on the criteria. Indeed, the sales assistance module 180 retrieves a list of HVAC units 102 that meet the criteria 308. For example, the user may select the criteria 308 to correspond with HVAC units that have not been serviced within a threshold amount of time, that have an age greater than an age threshold, that have an expected usable life lower than a life threshold, that have more than a threshold number of service tickets open, that are not already associated with a distributor, that include certain outdated components or modules, or any other suitable criteria 308.

Then, the map portion 304 may be populated with client indicators 310 to indicate locations (e.g., physical locations) of the HVAC units that meet the criteria 308. In other words, the sales assistance module 180 may visually indicate locations of the HVAC units 102 which meet the criteria to the user of the user device 124. The map portion 304 may include a client indicator 310 on the map portion 304 to correspond witch each HVAC unit 102 that meets the criteria 308. In some embodiments, the client indicators 310 may be ranked relative to one another based on how well they meet the criteria 308 (e.g., oldest units, closest units to the current location of the user device 124, owned by known building manager, etc.). For example, as shown a first client indicator 310 matches the criteria 308 more than a second client indicator 310 and a third client indicator 310.

Moreover, the sales assistance module 180 may also display a client list 320 of information related to the client indicators 310. In certain embodiments, the sales assistance module 180 may include the client list 320, the map portion 304, or a combination thereof. For example, as shown, the client list 320 includes a first row 322 having identifiers (e.g., data tags, titles, etc.) to denote the information contained in rows beneath the first row 322. Additionally, the client list 320 includes a number of entries 324 that correspond to HVAC units 102 that meet the criteria 308. As shown, the first row 322 comprises a name identifier, a contact information identifier, a unit type identifier, and a unit age identifier. In embodiments having both the map portion 304 and the client list 320, the identifiers in the first row 322 may correspond to the criteria 308 set by the user. However, it is to be understood that the client list and the criteria 308 may be set in any suitable manner, including by default.

Additionally, in some embodiments, the sales assistance module 180 may automatically query the service database 120 to monitor the HVAC units 102, and may push an alert or otherwise notify the distributor if an HVAC unit 102 that previously did not meet the criteria 308 has recently met the criteria 308. Moreover, the screen overlay 300 may include any other functions discussed herein, such as scrolling functions, and the like. In some embodiments, based on user selection of a client indicator 310, a corresponding data entry 324 in the client list 320 may be highlighted, bolded, or otherwise emphasized to enable the user to rapidly correlate the data entry 324 to the selected client indicator 310. It is to be understood that all or only a portion of the above noted functions of the sales assistance module 180 may be included in the integrated application 160. Moreover, each function of the integrated application 160 may be combined, resized, changed in order, associated with other modules, or the like.

Through the sales assistance module 180, the distributor may use the contact information to contact owners of the HVAC units to discuss upgrade and service opportunities. As such, the sales assistance module 180 enables the distributor to more easily identify and contact clients to discuss sale opportunities, all within the integrated application.

Accordingly, the present disclosure is directed to an integrated application for a user device to enable a user to access real-time, up-to-date information directly related to a selected HVAC unit. The integrated application may collect and combine multiple, previously disparate sources of information for rapid user access. In some embodiments, these information sources relate to operating data, service history data, reference manuals, contact information, part stores, sale-related data, and the like that is stored and constantly updated in a service database. In this manner, service technicians may easily locate HVAC units, log details related to the HVAC units, perform and log service actions, order parts, and/or locate sale opportunities related to the HVAC units. Moreover, via the sales assistance module 180, the integrated application enables distributors to locate HVAC units meeting certain criteria, and provide relevant marketing materials, advertisements, and the like to the end users of the HVAC units.

While only certain features and embodiments of the present disclosure have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure. Furthermore, in an effort to provide a concise description of the embodiments, all features of an actual implementation may not have been described (i.e., those unrelated to the presently contemplated best mode of carrying out the disclosure, or those unrelated to enabling the claimed features). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A system, comprising:
a user device;
a service database storing first data related to a plurality of heating, ventilating, and/or air conditioning (HVAC) systems corresponding to a plurality of locations; and
one or more processors configured to:
receive, from the user device, location data indicative of a location of the user device;
identify, in the service database and based on the location data, an HVAC system profile corresponding to an HVAC system of the plurality of HVAC systems; and
transmit second data indicative of at least a portion of the HVAC system profile to the user device and present the second data on a display of the user device.

2. The system of claim 1, wherein the one or more processors are configured to:
determine, from the HVAC system profile, information indicative of a configuration of the HVAC system, a service history corresponding to the HVAC system, operating data corresponding to the HVAC system, a reference manual corresponding to the HVAC system, sales assistance data corresponding to the HVAC system, part store data corresponding to the HVAC system, a startup guide corresponding to the HVAC system, a wiring diagram corresponding to the HVAC system, an engineering guide corresponding to the HVAC system, or any combination thereof; and
generate the second data from the information.

3. The system of claim 1, wherein the one or more processors are configured to:
determine, from the HVAC system profile, information indicative of a configuration of the HVAC system, a service history corresponding to the HVAC system, operating data corresponding to the HVAC system, a reference manual corresponding to the HVAC system, sales assistance data corresponding to the HVAC system, part store data corresponding to the HVAC system, a startup guide corresponding to the HVAC system, a wiring diagram corresponding to the HVAC system, and an engineering guide corresponding to the HVAC system; and
generate the second data from the information.

4. The system of claim 1, comprising one or more sensors configured to monitor operating conditions of the HVAC system, wherein the one or more processors are configured to:
receive, from the one or more sensors, sensor data indicative of the operating conditions of the HVAC system; and
store, on the service database and in the HVAC system profile, the sensor data.

5. The system of claim 1, wherein the one or more processors are configured to:
receive, from the user device, user device data indicative of a servicing of the HVAC system; and
store, on the service database and in the HVAC system profile, the user device data.

6. The system of claim 5, wherein the one or more processors are configured to:
receive, from an additional user device, additional user device data indicative of an additional servicing of an additional HVAC system of the plurality of HVAC systems; and
store, on the service database and in an additional HVAC system profile corresponding to the additional HVAC system, the additional user device data.

7. The system of claim 1, wherein the one or more processors are configured to:
present, on the display of the user device, a log-in interface;
receive, from the user device and via the log-in interface, log-in credentials;
authenticate, based on the log-in credentials, a user of the user device; and
after authenticating the user, transmit the second data to the user device and present the second data on the display of the user device, or both.

8. One or more tangible, non-transitory, computer-readable media storing instructions thereon that, when executed by one or more processors, are configured to cause the one or more processors to:
determine a correlation between a user device and a heating, ventilating, and/or air conditioning (HVAC) system;
identify, based on the correlation and in an HVAC service database storing a plurality of HVAC system profiles corresponding to a plurality of HVAC systems, an HVAC system profile corresponding to the HVAC system; and
present second data indicative of at least a portion of the HVAC system profile on a display of the user device.

9. The one or more tangible, non-transitory, computer-readable media of claim 8, wherein the instructions, when executed by the one or more processors, are configured to cause the one or more processors to determine the correlation between the user device and the HVAC system based on a physical proximity between the user device and the HVAC system.

10. The one or more tangible, non-transitory, computer-readable media of claim 8, wherein the instructions, when executed by the one or more processors, are configured to cause the one or more processors to:
determine, from the HVAC system profile, information indicative of a configuration of the HVAC system, a service history corresponding to the HVAC system, operating data corresponding to the HVAC system, a reference manual corresponding to the HVAC system, sales assistance data corresponding to the HVAC system, part store data corresponding to the HVAC system, a startup guide corresponding to the HVAC system, a wiring diagram corresponding to the HVAC system, and an engineering guide corresponding to the HVAC system; and
generate the second data from the information.

11. The one or more tangible, non-transitory, computer-readable media of claim 8, wherein the instructions, when executed by the one or more processors, are configured to cause the one or more processors to:
receive, from one or more sensors, sensor data indicative of operating conditions of the HVAC system; and
store, on the HVAC service database and in the HVAC system profile, the sensor data.

12. The one or more tangible, non-transitory, computer-readable media of claim 8, wherein the instructions, when executed by the one or more processors, are configured to cause the one or more processors to:
receive, from the user device, user device data indicative of a servicing of the HVAC system; and
store, on the HVAC service database and in the HVAC system profile, the user device data.

13. The one or more tangible, non-transitory, computer-readable media of claim 12, wherein the instructions, when executed by the one or more processors, are configured to cause the one or more processors to:
receive, from an additional user device, additional user device data indicative of an additional servicing of an additional HVAC system of the plurality of HVAC systems; and
store, on the service database and in an additional HVAC system profile corresponding to the additional HVAC system, the additional user device data.

14. The one or more tangible, non-transitory, computer-readable media of claim 8, wherein the instructions, when executed by the one or more processors, are configured to cause the one or more processors to:
present, on the display of the user device, a log-in interface;
receive, from the user device and via the log-in interface, log-in credentials;
authenticate, based on the log-in credentials, a user of the user device; and
after authenticating the user, present the second data on the display of the user device.

15. A system, comprising:
a user device;
a service database storing first data related to a plurality of heating, ventilating, and/or air conditioning (HVAC) systems; and
one or more processors configured to:
present, on a display of the user device, a web-based HVAC sales application including a search function;
receive, from the user device and via the search function, a search term corresponding to an HVAC system condition;
generate, based on the search term, a searching criteria;
search the service database to identify at least one HVAC system of the plurality of HVAC systems that meets a pre-defined relationship with the searching criteria; and
present, on the display of the user device, second data related to the at least one HVAC system.

16. The system of claim 15, wherein the one or more processors are configured to:
search the service database to identify a first HVAC system of the plurality of HVAC systems and a second HVAC system of the plurality of HVAC systems that meet the pre-defined relationship with the searching criteria;
determine a first extent to which the first HVAC system meets the pre-defined relationship with the searching criteria;
determine a second extent to which the second HVAC system meets the pre-defined relationship with the searching criteria; and
present, on the display of the user device and based on the first extent and the second extent, the second data having an ordered list of the first HVAC system and the second HVAC system.

17. The system of claim 15, wherein the one or more processors are configured to present, on the display of the user device, the second data related to the at least one HVAC system such that the second data includes a client list and contact information related to the at least one HVAC system.

18. The system of claim 15, comprising a plurality of sensors configured to monitor a plurality of HVAC system conditions corresponding to the plurality of HVAC systems, wherein the one or more processors are configured to:
receive, from the plurality of sensors, sensor data indicative of the plurality of HVAC system conditions;
store, on the service database and in a plurality of HVAC system profiles corresponding to the plurality of HVAC systems, the sensor data; and
transmit an alert to the user device in response to an identified HVAC system condition of the plurality of HVAC system conditions meeting an identified pre-defined relationship with a threshold HVAC system condition.

19. The system of claim 18, wherein the threshold HVAC system condition comprises a parameter indicative of energy efficiency or consumption.

20. The system of claim 15, wherein the one or more processors are configured to:
monitor a plurality of ages corresponding to the plurality of HVAC systems; and
transmit an alert to the user device in response to an age of the plurality of ages exceeding a threshold age.
